(19) United States
(12) Patent Application Publication
(10) Pub. No.: US 2012/0233990 A1
(43) Pub. Date: Sep. 20, 2012

(54) METHOD FOR OPERATING A HYDRAULIC DRIVE DEVICE AND METHOD OF OPERATING THE SAME

(75) Inventor: Bert Brahmer, Bruchsal (DE)

(73) Assignee: VOITH PATENT GMBH, Heidenheim (DE)

(21) Appl. No.: 13/378,538

(22) PCT Filed: May 3, 2011
(86) PCT No.: PCT/EP2011/057009

§ 371 Date: Dec. 15, 2011

(30) Foreign Application Priority Data
Jul. 27, 2010 (DE) 10 2010 038 448.8

(51) Int. Cl. F16D 31/02

(52) U.S. Cl. 60/327; 60/431

(57) ABSTRACT

The invention relates to a method for operating a hydraulic drive device comprising a hydraulic piston-cylinder unit having a working piston that can be moved in a working direction between an upper dead point and a lower dead point, a set point for the position of the working piston in the working direction being predefined, and an actual value of the position of the working piston in the working direction being interrogated, and the movement of the working piston being regulated as a function of the set point and the actual value. The invention additionally relates to a hydraulic drive device.

### BACKGROUND OF THE INVENTION

The invention relates to a method for operating a hydraulic drive device comprising a hydraulic piston-cylinder unit having a working piston that can be moved in a working direction between an upper dead point and a lower dead point, a set point for the position of the working piston in the working direction being predefined, and an actual value of the position of the working piston in the working direction being interrogated, and the movement of the working piston being regulated as a function of the set point and the actual value.

The invention additionally relates to a hydraulic drive device comprising a hydraulic piston-cylinder unit and having a working piston that can be moved in a working direction between an upper dead point and a lower dead point, a setting device being provided to predefine a set point for the position of the working piston in the working direction, it being possible for an actual value of the position of the working piston in the working direction to be interrogated, and control feedback being provided, which interacts with the setting device in order to predefine the set point as a function of the actual value.

The hydraulic drive devices mentioned are used in particular in punching, embossing, nibbling or bending machines. During a machining process, a double stroke of the working piston is regularly required, for example a movement starting from the upper dead point to the lower dead point and back to the upper dead point.

For the quality of the working result of the aforementioned processing machines, in particular the precision and reproducibility of the positions of the upper and lower dead point are critical. This can be seen, for example, in the case of an embossing or bending operation, since here the position of the lower dead point directly determines the deformation of the workpiece processed.

In this connection, it has proven to be problematical that, during the control of the movement of the working piston by predefining the set point, the actual value of the position of the working piston regularly deviates from the set point of the position. This lag, as it is known, leads to inaccuracies in the precision and reproducibility of the upper and/or lower dead point, and therefore to inaccuracies in the fabrication process.

Lag can have various causes. If, for example, the supply to the hydraulic piston-cylinder unit for moving the working piston with hydraulic fluid is carried out via a proportional valve having a displaceable valve spool for setting a variable valve opening, then, on account of its usually lower mass, the valve spool can be controlled much more quickly than the massive working piston. A change in the set point can therefore be carried out comparatively quickly, whereas the speed of the positional change of the working piston is limited by inertial forces. Furthermore, in the case of control with a proportional valve in the manner described, problems in the accuracy of the setting of an actual value result from the fact that, in the proportional control, the valve opening is changed proportionally with respect to the deviation of the actual value from the set point. As the actual value approaches the set point, the valve opening and therefore the volume flow through the control valve becomes small, which delays the movement of the working piston to the intended position.

During a double stroke, in order to move the working piston precisely and reproducibly to the upper and/or lower dead point, measures for regulating and coordinating set point and actual value are consequently necessary and variously known.

To explain the technical background, FIG. 2a shows the variation over time of set point (X_{CMD}) and actual value (X_{FBK}) during execution of a double stroke between an upper dead point (OT) and a lower dead point (UT) with a hydraulic drive device of the type mentioned above. Here, the progressive time is plotted on the abscissa (horizontal axis), the position of the working piston on the ordinate (vertical axis). Starting from the upper dead point OT, firstly the set point X_{CMD}, is predefined at the lower dead point UT. As a result, the actual value X_{FBK} approximates the lower dead point UT. For the reasons outlined above, the change over time in the actual value X_{FBK} takes place with a delay as compared with the set point X_{CMD}. The actual value X_{FBK} runs behind (“lags”) the set point X_{CMD}. In particular in the area around the lower dead point UT, the actual value X_{FBK} changes only slowly over time (as can be seen from the shallow slope of the curve X_{FBK}), which can be attributed to the small deviation of the actual value X_{FBK} from the set point X_{CMD}.

In order to initiate the movement reversal required for a double stroke, in the variation over time according to FIG. 2a, a lower position threshold UT1 is predefined. As soon as the actual value X_{FBK} reaches the lower position threshold UT1 (at the time T_{UT1} in FIG. 2a), the set point X_{CMD} is led back to the upper dead point OT. After this change in the set point X_{CMD}, the actual value X_{FBK} still initially runs in its original direction toward the lower dead point UT (for example because of the mass moment of inertia of the working piston) and, following the movement reversal, runs from the lower dead point UT in the direction of the upper dead point OT. Here too, for the aforementioned reasons, once more a deviation occurs between the actual value X_{FBK} and the set point X_{CMD} (“lag”), the change over time in the actual value X_{FBK} becoming slower the more the actual value X_{FBK} approaches the set point X_{CMD}.

In order to be able to define an end of the double stroke expediently, an upper position threshold OT1 is predefined below the upper dead point OT. At a time T_{OT1} the actual value X_{FBK} reaches the upper position threshold OT1. The upper position threshold OT1 is chosen to be so close to the upper dead point OT that reaching the upper position threshold OT1 can be viewed as the end of the double stroke. In this sense, the time period from the start of the process outlined to the time T_{OT1} can be viewed as the process time of the double stroke.

A similar control method can be gathered, for example, from EP 1 462 660 A1.

When a hydraulic drive device mentioned at the beginning is used in processing machines, in addition to the accuracy of the piston movement, which is to say the precision and reproducibility of the upper and lower dead point, the speed of the working process is additionally critical for economy. Normally, as short as possible a time period for the execution of a double stroke is desired. This makes fast movements and fast movement changes of the working piston necessary.

In the previously described control of the double stroke by means of a proportional valve, in particular the problem occurs here that the valve opening of the proportional valve and therefore the volume flow of hydraulic fluid for supplying the drive device becomes small in the event of a small deviation of the actual value from the set point. For this reason, the positional adjustment of the working piston is carried out only slowly as soon as the actual value lies in the region of the desired set point (which is to say, in particular, the upper and lower dead point). This can lead to an undesirably long process time of the double stroke.

### SUMMARY OF THE INVENTION

The present invention permits operation of a hydraulic drive device with improved economy.

The method according to the invention is distinguished by the fact that, in order to carry out a double stroke of the working piston starting from the upper dead point, firstly the set point is predefined at a lower overcontrol position below the lower dead point and, when the actual value reaches a changeover value above the lower dead point, to reverse the movement of the working piston the set point is predefined at an upper overcontrol position above the upper dead point and, after that, when the actual value reaches a quiescent switching value below the upper dead point, the set point is predefined at the upper dead point.

The use of this method is suitable in particular for operating a hydraulic drive device in punching, embossing, nibbling or bending machines.

In the method according to the invention, during to a great extent the entire movement starting from the upper dead point as far as the lower dead point and back as far as the quiescent switching value, a comparatively large deviation between the predefined set point and the actual value is brought about. As distinct from the prior art illustrated at the beginning, overrunning of the hydraulic drive device is accordingly deliberately brought about. There is therefore no waiting until the actual value virtually coincides with the set point.

As a result, firstly the control time between pre-definition of a desired set point and establishment of the associated actual value is considerably shorter. This becomes clear, for example, during operation of a hydraulic drive device having a control valve operating as a proportional valve, in which a valve opening for supplying the hydraulic drive with hydraulic fluid proportionally to the deviation between the set point and the actual value is provided. Since, in the method according to the invention, a comparatively large deviation between set point and actual value is deliberately brought about, in the control valve described, a large valve opening is established virtually over the entire double stroke. Therefore, the drive device is supplied with a comparatively large volume flow of hydraulic fluid, and the movement of the working piston is carried out more quickly, in particular in the area around the upper and lower dead point, than in the known control method described.

Overall, with the operating method according to the invention, a considerably shortened process time for a double stroke is achieved whilst maintaining the precision of the piston movement at the upper and at the lower dead point and, consequently, improved economy is achieved.

In order to ensure high precision of the movement of the working piston in the method according to the invention, the changeover value (UT2) and/or the lower overcontrol position (XUT) are advantageously chosen in such a way that, as the movement of the working piston is reversed, the actual value is located at the lower dead point.

In certain applications, however, it may also be advantageous if the changeover value and/or the lower overcontrol position are chosen in such a way that the actual value is always above the lower dead point.

As a further aspect of the method according to the invention, provision can be made for the quiescent switching value and/or the upper overcontrol position to be chosen in such a way that the actual value is always below or equal to the upper dead point. This prevents the working piston running out beyond the upper dead point.

If, by using the method according to the invention, a hydraulic drive device is operated which has a control valve for supplying the piston-cylinder unit with hydraulic fluid for moving the working piston, it being possible for the control valve to be switched at least between a deployment position for moving the working piston in the working direction (which means in the direction from the upper dead point toward the lower dead point) and a retraction position for moving the working piston counter to the working direction, an advantageous refinement of the method results from the fact that a control deviation between set point and actual value is determined and that the control valve is switched into the retraction position or into the deployment position as a function of the control deviation.

In order to achieve the object set at the beginning, in addition a hydraulic drive device is proposed which has a hydraulic piston-cylinder unit having a working piston that can be moved in a working direction between an upper dead point and a lower dead point, in addition a setting device being provided to define or predefine a set point for the position of the working piston in the working direction, it being possible for an actual value of the position of the working piston in the working direction to be interrogated, and, in addition, control feedback being provided, which interacts with the setting device in order to predefine the set point as a function of the actual value. In the drive device according to the invention, the setting device is formed in such a way that the set point can be predefined at a lower overcontrol position below the lower dead point and at an upper overcontrol position above the upper dead point, and the control feedback is designed in such a way that a changeover value UT2 above the lower dead point UT and a quiescent switching value OT2 below the upper dead point OT can be predefined, and that the control feedback interacts with the setting device in such a way that when the actual value reaches the changeover value UT2, the set point is predefined at the upper overcontrol position XOT, and that when the actual value reaches the quiescent switching value OT2 from the direction of the lower dead point UT, the set point is predefined at the upper dead point OT.

The control feedback designates, in the widest sense, means for picking up and processing the actual value interrogated in order to predefine a set point. Mechanical feedback is conceivable here, for example between working piston and setting device, but also electronic devices.

A device of this type can advantageously be operated by the method explained above. Therefore, with the device according to the invention, comparatively fast piston movements and movement changes are possible, which permits short process times for a double stroke of the working piston and therefore operation with increased economy.

The device is advantageously refined further by position indicator being provided for interrogating the actual value of the position of the working piston, in particular in the working direction. Suitable for this purpose are, for example, optical, electronic, magnetic or mechanical measuring devices.

A particularly preferred refinement results from the fact that a control valve is provided for supplying the piston-cylinder unit with hydraulic fluid for moving the working piston, it being possible for the control valve to be switched at least between a deployment position for moving the working piston in the direction from the upper dead point to the lower dead point (which means in the working direction) and a retraction position for moving the working piston in the direction from the lower dead point to the upper dead point (which means counter to the working direction). In this refinement, the control valve has to be actuated only to predefine the set point.

Here, it is advantageous if the control valve with the control feedback can be switched as a function of the set point and as a function of the actual value. The control feedback in this case acts as a setting device or comprises the setting device or is a constituent part of the setting device.

As a further refinement, the control valve can be switched between the deployment position, the retraction position and a neutral position, in which the piston-cylinder unit is supplied with no hydraulic fluid or in which at least a supply to the piston-cylinder unit with hydraulic fluid for the purpose of moving the working piston is suppressed. This makes it possible to keep the working position in a rest position. In particular, a 3/3-way or a 4/3-way directional control valve is suitable as control value.

Advantageously, the control feedback is designed in such a way that a holding value for the position of the working piston can be predefined, and that the control valve is switched into the neutral position when the actual value coincides or at least substantially coincides with the holding value or both the set point and the actual value coincide or at least substantially coincide with the holding value, for example within a pre-definable position window around the holding value or between a position threshold and the holding value. As a result, the working piston can be kept at rest when the end of a process, for example a double stroke, has been reached.

In order to refine the device further, the control valve is designed as a continuously operated valve, and the control feedback is designed in such a way that the piston-cylinder unit is supplied with a volume flow that is greater the more the actual value deviates from the set point. On the basis of this proportional control, the movement of the working piston becomes faster the more the variation of the actual value over time trails the variation of the predefined set point over time. The control valve is, for example, designed as a proportional valve with a displaceable valve spool, it being possible for a continuously variable valve opening to be provided by displacing the valve spool.

A further refinement results from the fact that the control valve is designed as a proportional valve with a continuously variable control opening and that the control feedback is designed in such a way that a control deviation between set point and actual value can be determined, and that the control opening can be varied proportionally with respect to the control deviation. On account of the continuously variable control opening of the proportional valve, continuous adjustment of a volume flow through the control valve is possible. The control deviation is determined in particular as the difference between set point and actual value, a positive value being assigned for example starting from the upper dead point in the direction of the lower dead point, and therefore the control deviation being positive when the set point is closer to the lower dead point than the actual value. Of course, the choice of sign can also be made in the opposite way.

In order to predefine the set point, the setting device preferably comprises a linear motor, in particular an electric motor, or a rotary motor-piston-rack unit. It is also conceivable for the set point to be predefined via a rotary motor which interacts with a control valve that can be switched between retraction position and deployment position by rotation. It is further conceivable for the actual value to be supplied to the control valve by rotating a pinion via a rack which meshes with a pinion.

In order also to permit complex movement sequences for the working piston, for example a double stroke with a piston speed that varies section by section, whilst simultaneously maintaining the precision of the upper and lower dead point, a CNC control unit is advantageously provided, by means of which the setting device for predefining the set point can be controlled.

### BRIEF DESCRIPTION OF THE DRAWINGS

Further advantageous refinements of the invention can be gathered from the following description, by using which the embodiments of the invention illustrated in the figures are described and explained in more detail.

In the figures:

FIG. 1 shows a schematic illustration of a hydraulic drive device according to the invention;

FIG. 2a shows the variation over time of set point and actual value during a double stroke in order to explain the technical background;

FIG. 2b shows the variation over time of set point and actual value during a double stroke according to the method of the invention.

### DETAILED DESCRIPTION

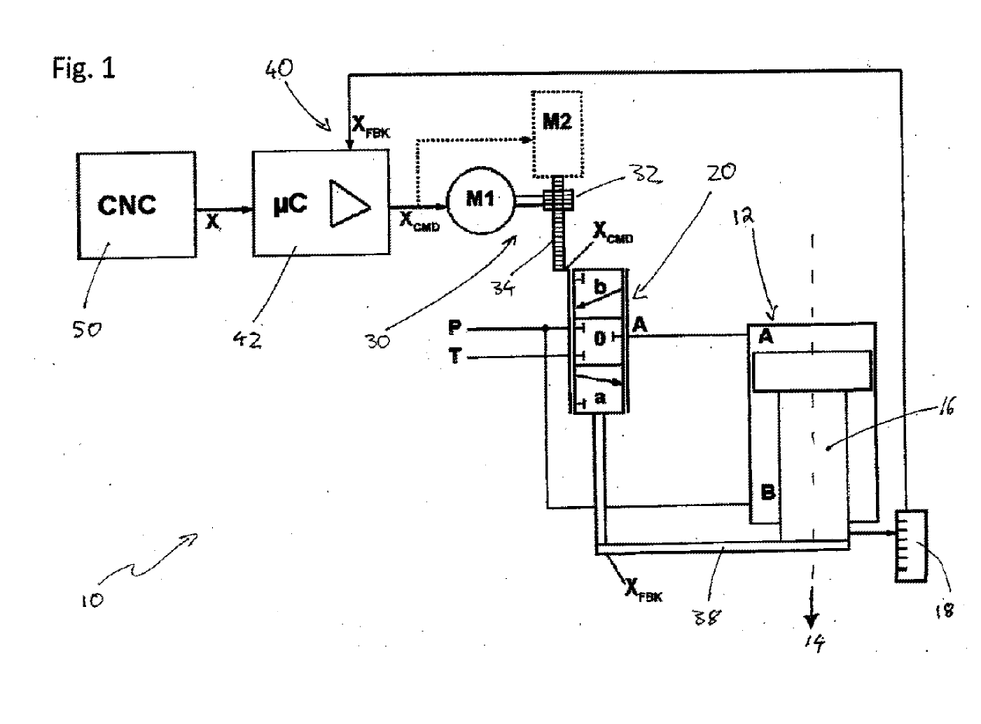

The hydraulic drive device 10 illustrated in FIG. 1 comprises a hydraulic piston-cylinder unit 12, which has a working piston 16 that can be moved in and counter to a working direction 14. The working direction 14 is indicated in FIG. 1 by an arrow. The working piston 16 can be moved between an upper dead point OT, which in FIG. 1 corresponds to a state retracted completely counter to the working direction 14, and a lower dead point UT (state of the working piston 16 deployed completely in the working direction 14).

To determine an actual value X_{FBK}, which represents the position of the working piston 16 in the working direction 14, position indicator 18 is provided.

The working piston 16 delimits a deployment pressure chamber A, which can be pressurized with a hydraulic pressure fluid in order to move the working piston 16 in the working direction 14. In addition, the working piston 16 delimits a refraction pressure chamber B, which can be pressurized with pressure fluid in order to retract the working piston 16 counter to the working direction 14. Here, the hydraulic piston-cylinder unit 12 is designed as a hydraulic differential cylinder, the effective hydraulic surface for moving the working piston 16 for the retraction pressure chamber B being smaller than the effective hydraulic surface for the deployment pressure chamber A.

To supply the piston-cylinder unit 12 with hydraulic fluid, the hydraulic drive device 10 has a control valve 20. The control valve 20 is designed as a 3/3-way directional control valve, which has a working connection connected to the deployment pressure chamber A, and also a pressure connection P and a tank connection T. The control valve 20 can be switched between three switching positions a, 0, b; in the switching position a the pressure connection P is connected to the working connection, i.e. to the deployment pressure chamber A. In the switching position b the deployment pressure chamber A is connected to the tank connection T. The switching position 0 represents a neutral position, in which the drive pressure chamber A is closed off against the supply or discharge of hydraulic fluid. In all three switching positions, the retraction pressure chamber B with the smaller effective hydraulic surface has a pressure connection to the pressure connection P.

In order to define or predefine a set point X_{CMD} for the position of the working piston 16, a setting device 30 is provided in the drive device 10. The setting device 30 comprises a rotary motor M1, by means of which a pinion 32 which meshes with a rack 34 can be rotated. The rack 34 can therefore be displaced by the rotary motor M1. In FIG. 1, furthermore, a dotted line illustrates an alternative implementation which has a linear motor M2 by means of which the rack 34 can be displaced.

In the example illustrated, the set point is predefined by means of interaction of the setting device 30 with the control valve 20, the setting device 30 in particular actuating the control valve 20.

To this end, for example the actual value X_{FBK} of the working piston 16 is fed mechanically via a yoke 38 to a control input of the control valve 20. Also conceivable, however, is an electric feed. With regard to the feed, it is for example conceivable for the control valve 20 to comprise a valve spool (not illustrated) that can be displaced between positions assigned to the switching positions a, 0, b; by displacing the valve spool into the position a (or b), a control opening of the control valve 20 is provided which is larger the further the valve spool is displaced into the position a (or b). The valve spool is coupled here via the yoke 38 to the movement of the working piston 16, so that the control valve 20 operates in the manner of a copying valve. As indicated in FIG. 1, in this case the setting device 30 acts on a further control input of the control valve 20, not illustrated. This further control input can interact, for example, with a displaceably mounted control bushing (not illustrated) belonging to the control valve, the valve spool being displaceably mounted in the control bushing.

As a result of such an arrangement, the control valve 20 is switched into the switching position a if the set point X_{CMD} leads the actual value X_{FBK} in the working direction 14. Conversely, the control valve 20 is switched into the switching position b if the set point X_{CMD} remains behind the actual value X_{FBK}. The control valve 20 is switched into the neutral position 0 if the set point X_{CMD} coincides with the actual value X_{FBK}.

In order to predefine the set point X_{CMD} as a function of the actual value X_{FBK}, control feedback 40 is provided in the hydraulic drive device 10. The control feedback 40 comprises a control device 42, which is fed the actual value X_{FBK} interrogated by the position indicator 18, for example as an electric signal. Depending on the signal X_{FBK}, the control device 42 then generates an output signal to predefine the set point X_{CMD} for the setting device 30.

The drive device 10 further comprises a CNC control device 50, for example for predefining a timed movement sequence. By means of the CNC control device 50, time-variable position values X can be predefined, which are likewise fed to the control device 42. The control device 42 consequently controls the setting device 30 for predefining the set point X_{CMD}, on the one hand as a function of the actual value X_{FBK}, on the other hand as a function of the position values X.

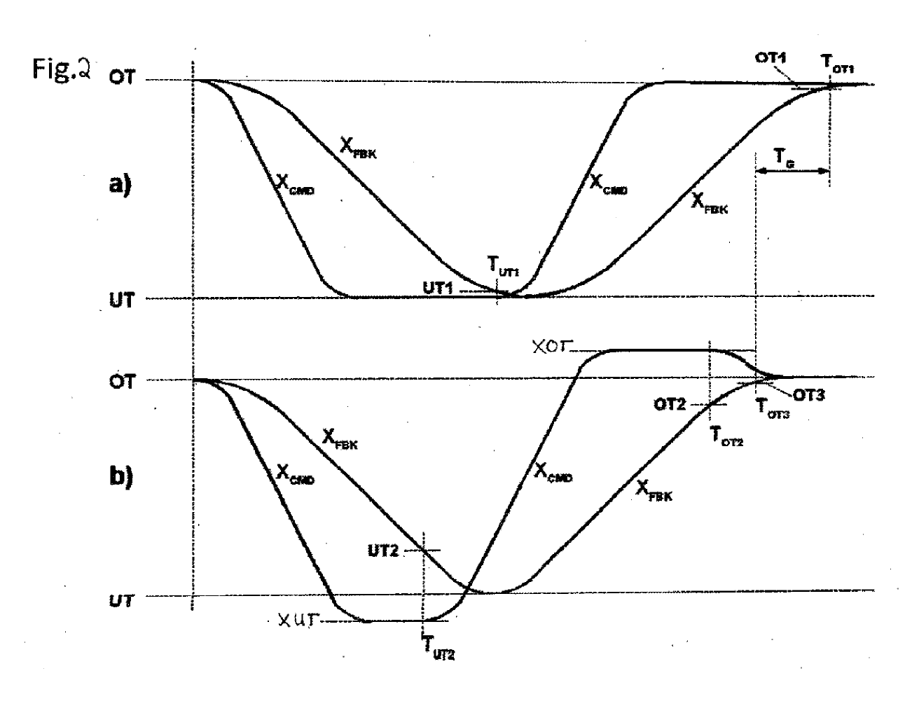

In the following text, using FIG. 2b, the variation over time of the set point X_{CMD} and of the actual value X_{FBK} when carrying out a double stroke of the working piston 16 with the hydraulic drive device 10 will now be explained, reference being made to the hydraulic drive device 10 illustrated in FIG. 1. In the illustration of FIG. 2b, position values which correspond to a position of the working piston 16 in the working direction 14 are plotted on the ordinate (vertical axis), and the time variation is plotted on the abscissa (horiztonal axis).

At the start of the process, the working piston 16 is at the upper dead point OT, which means in a retracted state counter to the working direction 14. Accordingly, the actual value X_{FBK} and the set point X_{CMD} are located at the upper dead point OT. However, it is also conceivable that the set point X_{CMD} is set to another value and the actual value X_{FBK} is located only instantaneously at the upper dead point (OT).

In order to initiate a double stroke between the upper dead point OT and the lower dead point UT, firstly the set point X_{CMD} is predefined at a lower overcontrol position XUT below the lower dead point UT.

For this purpose, in the drive device 10 the CNC control device 50 generates a corresponding position value X, which is fed to the control device 42. The control device 42 then controls the rotary motor M1 of the setting device 30 in such a way that the control valve 20 is switched into the switching position a. In the process, for example, a valve spool provided in the control valve 20 is displaced in a corresponding way. Accordingly, the possible speed at which the set point X_{CMD} can be led from the upper dead point OT to the lower overcontrol position XUT is limited, in particular by the speed of movement of the valve spool. Consequently, in FIG. 2b the set point X_{CMD} is not led to the lower overcontrol position XUT in a stepwise manner but continuously.

On the other hand, it is also conceivable for the variation over time of the set point X_{CMD} to be deliberately predefined in a continuous manner by the CNC control device 50.

On account of the mass moment of inertia of the working piston 16 and/or on account of the limited volume flow of hydraulic fluid through the control valve 20, the actual value X_{FBK} does not follow the set point X_{CMD} directly but remains behind the latter as time progresses.

After a time T_{UT2}, the actual value X_{FBK} reaches a lower changeover value UT2. This is detected by the position indicator 18 and fed to the control device 42. The set point X_{CMD} is then predefined at an upper overcontrol position XOT by means of the setting device 30.

As explained above, this change in the set point X_{CMD} is not carried out in a stepwise manner but with a continuous variation over time. In particular, it can be seen in FIG. 2b that, starting from the time T_{UT2}, the set point X_{CMD} is still located below the lower dead point UT for a certain time period. Consequently, also after the time T_{UT2}, the actual value X_{FBK} of the position of the working piston 16 approaches the lower dead point UT still further before a reversal of the movement is carried out and the actual value moves back in the direction of the upper dead point OT.

At a time T_{OT2} the actual value X_{FBK} exceeds, from the direction of the lower dead point UT, a quiescent switching value OT2 below the upper dead point OT. As a result, the set point X_{CMD} is led back from the upper overcontrol position XOT to the upper dead point OT.

In the example according to FIG. 2b, firstly the lower overcontrol position XUT and secondly the changeover value UT2 are chosen in such a way that the actual value X_{FBK} is located exactly at the lower dead point UT at a reversal of the movement. By means of suitable choice of the changeover value UT2 and/or the lower overcontrol position XUT, however, the actual value X_{FBK} can in particular be set to a freely selectable value between the upper dead point OT and the lower dead point UT at the time of reversal of the movement.

Furthermore, the variation in the movement of the actual value X_{FBK} after the reversal of the movement can be influenced by means of a suitable definition of the quiescent switching value OT2 and/or the upper overcontrol position XOT.

The speed of change of the actual value X_{FBK} can firstly be varied directly by the set point X_{CMD} being predefined with an appropriate variation over time.

If a proportional valve is used for the control valve 20, as explained above, then the volume flow of hydraulic fluid through the control valve 20 is greater, and therefore the movement of the working piston 16 is faster, the more strongly the actual value X_{FBK} deviates from the set point X_{CMD}. Thus, the rate of change of the actual value X_{FBK} can also be influenced by the deviation between actual value X_{FBK} and set point X_{CMD} being set accordingly. This can also be done by choosing the lower overcontrol position XUT, the changeover value UT2, the upper overcontrol position XOT and the quiescent switching value OT2. In particular as a result, a fast or else a delayed reversal of the movement can be brought about.

For comparative purposes, an upper position threshold OT3 which exceeds the actual value X_{FBK} at a time T_{OT3} has been drawn in FIG. 2b. As in the explanation relating to the technical background in FIG. 2a, this upper position threshold OT3 is used to define an end of the double stroke. The time period from the start of the process as far as the time T_{OT3} therefore serves as a measure of the process time of the double stroke. From a comparison of FIGS. 2a and 2b it can be seen that, by using the method according to the invention, the process time can be shortened by a time interval T_{G} (drawn in FIG. 2a).

1. A method for operating a hydraulic drive device (10) comprising
moving a working piston of a hydraulic cylinder between an upper dead point and a lower dead point;
defining a set point for the position of the working piston;
determining an actual value of the position of the working piston;
regulating the movement of the working piston as a function of the set point and the actual value
performing a double stroke of the working piston by starting from the upper dead point,
defining the set point at a lower overcontrol position below the lower dead point
reversing the movement of the working piston when the actual value reaches a changeover value above the lower dead point, by defining the set point at an upper overcontrol position above the upper dead point and,
defining the set point at the upper dead point when the actual value reaches a fixed switching value below the upper dead point.

2. The method according to claim 1 wherein at least one of the changeover value or the lower overcontrol position are chosen in such a way that, as the movement of the working piston is reversed, the actual value is located at the lower dead point.

3. The method according to claim 1 wherein at least one of the fixed switching value or the upper overcontrol position are chosen in such a way that the actual value is always below or equal to the upper dead point.

4. A hydraulic drive device comprising
a hydraulic piston-cylinder unit having a working piston (16) that can be moved between an upper dead point and a lower dead point,
a setting device to define a set point for the position of the working piston,
control feedback which interacts with the setting device to define the set point as a function of an actual value of the position of the working piston, where the setting device defines
the set point at a lower overcontrol position below the lower dead point
an upper overcontrol position above the upper dead point,
a changeover value above the lower dead point and
a fixed switching value below the upper dead point,
the control feedback interacts with the setting device in such a way that when the actual value reaches the changeover value, the set point is define at the upper overcontrol position, and that when the actual value reaches the fixed switching value from the direction of the lower dead point, the set point is defined at the upper dead point.

5. The device (10) according to claim 4, wherein an indicator is provided for determining the actual value of the position of the working piston.

6. The device according to claim 4, wherein a control valve supplies the piston-cylinder unit with hydraulic fluid for moving the working piston for and is switched at least between an extended position for moving the working piston in the direction from the upper dead point to the lower dead point and a retraction position for moving the working piston in the direction from the lower dead point to the upper dead point.

7. The device according to claim 6, wherein the control valve with the control feedback is switched as a function of the set point and of the actual value.

8. The device according to claim 6, wherein the control valve is switched between the extended position, the retraction position and a neutral position, in which a supply to the piston-cylinder unit with hydraulic fluid for the purpose of moving the working piston is suppressed.

9. The device according to claim 8, wherein the control feedback defines a holding value for the position of the working piston, and switches to the neutral position value when the actual value at least substantially coincides with the holding value or both the set point and the actual value at least substantially coincide with the holding value.

10. The device according to claim 6, wherein the control valve is a continuously operated valve, and the control feedback causes the piston-cylinder unit to be supplied with a volume flow that is greater the more the actual value deviates from the set point.

11. The device according to claim 6, wherein the control valve is a proportional valve with a continuously variable control opening for continuous adjustment of a volume flow of hydraulic fluid through the control valve, and a control deviation between the set point and the actual value is determined, and the control opening is varied proportionally with respect to the control deviation.

12. The device according to claim 4, wherein the setting device comprises a linear motor or a rotary motor-piston-rack unit.

13. The device according to claim 4, wherein a CNC control unit is provided to control the setting device for defining the set point.
